(19) United States
(12) Patent Application Publication
(10) Pub. No.: US 2025/0036906 A1
(43) Pub. Date: Jan. 30, 2025

(54) ASSEMBLY AND METHODS FOR MOBILE ENROLMENT OF BIOMETRICALLY-AUTHORISABLE SMART-CARDS

(71) Applicant: ZWIPE AS, Oslo (NO)

(72) Inventor: Robert MUELLER, Riemerling (DE)

(21) Appl. No.: 18/713,018

(22) PCT Filed: Nov. 25, 2022
(86) PCT No.: PCT/EP2022/083352

§ 371 Date: May 23, 2024

(30) Foreign Application Priority Data
Nov. 25, 2021 (GB) 2117047.7

(51) Int. Cl. G06K 19/07

(52) U.S. Cl. CPC G06K 19/0718; G06K 19/0724; G06K 19/0707

(57) ABSTRACT

An assembly comprising a smartcard (100) and a signal booster (200), wherein the smartcard comprises: an antenna (103) for contactless power harvesting; and a biometric capture device (102), wherein the smartcard is configured to perform biometric enrolment using the biometric capture device and to perform biometric authorisation using the biometric capture device after biometric enrolment has been completed, and wherein the signal booster (200) comprises: a first antenna (201) configured to inductively couple with the smartcard antenna (103), and a second antenna (202) configured to inductively couple with a near field communication antenna (302) of a smartphone (301), wherein the second antenna is smaller than the first antenna, and wherein the first and second antennas are in electrical communication such that power received via the second antenna from the antenna of the smartphone is transmitted via the first antenna to the antenna of the smartcard.

The present invention relates to an assembly comprising a smartcard and a signal booster. The invention is particularly applicable for (but not limited to) use in biometric enrolment systems and methods.

Biometrically authorisable devices such as smartcards are becoming increasingly more widely used and include, for example access cards, credit cards, debit cards, prepaid cards, loyalty cards, identity cards, and so on. Smartcards are electronic cards with the ability to store data and to interact with the user and/or with outside devices, for example via contactless technologies such as near field communication (NFC). These smartcards can interact with readers to communicate information in order to enable access, to authorise transactions and so on.

Biometric authorisation such as fingerprint authorisation is becoming increasingly more widely used. Smartcards with complete on-board biometric authorisation are called Biometric System-on-Card (BSoC, e.g. ISO/IEC 17839-1) and can interact with the user via integrated biometric capture devices (such as e.g. fingerprint sensors) in order to enable access to secure features of the smartcard, for example in order to authorise financial transactions.

Biometrically-authorisable smartcards require completion of an enrolment process (e.g. the capturing and registration of a user's fingerprint) before they can be used. It is desirable to use the biometric capture device integrated in the smartcard during enrolment. This avoids the need for potentially insecure transmission of the biometric data over a network, and instead the biometric data can be securely kept in the smartcard with no requirement for external storage or transmission. It also increases the accuracy of a subsequent biometric identification process since the exact same capture device is used for enrolment as is used for the later authentication by comparing the user's currently captured biometric probe data with previously stored biometric reference data. Such an enrolment process requires that the smartcard be powered.

For smartcards with no on-board power source, power may be supplied to the card for use during the enrolment process via a passive enrolment device/sleeve with an internal battery that is arranged to provide power to the smartcard via an electrical connection, such as disclosed in WO 2020/002678 A1. Alternatively, power may be supplied to the smartcard via a wired connection to an external power source, such as power drawn via a connection with an ISO/IEC 7816 contact plate of the smartcard or with a dedicated interfacing device connecting in a contactless manner, e.g. using an ISO/IEC 14443-3 interface. However, there are technical constraints from the external power source in relation to the current drawn via this approach as well as difficulties in handling a large power at the smartcard itself.

According to one aspect the present invention provides an assembly comprising a smartcard and a signal booster, wherein the smartcard comprises: an antenna for contactless power harvesting; and a biometric capture device, wherein the smartcard is configured to perform biometric enrolment using the biometric capture device and to perform biometric authorisation using the biometric capture device after biometric enrolment has been completed, and wherein the signal booster comprises: a first antenna configured to inductively couple with the smartcard antenna, and a second antenna configured to inductively couple with a near field communication antenna of a smartphone, wherein the second antenna is smaller than the first antenna, and wherein the first and second antennas are in electrical communication such that power received via the second antenna from the antenna of the smartphone is transmitted via the first antenna to the antenna of the smartcard.

It is possible to use a smartphone (e.g. belonging to the cardholder) to supply power to the smartcard via a near-field communication (NFC) antenna during enrolment. To do this, a wireless connection is utilised, with power being harvested from the NFC antenna of the smartphone. Many modern smartphones comprise a suitable NFC antenna for this purpose.

The smartcard may be a passive smartcard. That is, the smartcard may be powered only by energy harvested from an external RF excitation field, for example an RF excitation field generated by the smartphone and transferred to the smartcard via the signal booster.

Mobile enrolment enables the performing of enrolment flexibly by the user at home or on the go. However, one challenge with of the use of a smartphone for mobile enrolment is that the NFC field from many smartphones is not well suited for inductive coupling with the antennas of typical smartcards. Often, even if sufficient coupling is possible to power the smartcard, it will only be sufficient to power the smartcard directly for enrolment in certain positions and it is difficult for users to identify and hold the smartcard stable in a suitable position beside the phone to achieve this.

The assembly according to the first aspect addresses these problems by utilising a signal booster including a first antenna configured to couple to the smartcard and a second antenna configured to couple to a smartphone; in this way energy harvesting from the smartphone and propagation into the smartcard can be improved. This provides a more reliable power supply to the smartcard than would be achieved coupling the smartphone to the smartcard directly. In addition, more stable communication between the smartphone and smartcard can be established.

A size and/or a shape and/or resonance frequency of the first antenna may match a size and/or a shape and/or resonance frequency of the smartcard antenna. This improves the stability of the inductive coupling and ensures a more stable power supply and communication between the respective antennas.

The assembly may comprise a first oscillating circuit connected to the first antenna and tuning the first antenna to match a tuning of the antenna of the smartcard. The assembly may comprise a second oscillating circuit connected to the second antenna. The first and second antennas may be in electrical communication via the first and/or second oscillating circuits. Oscillating circuits allow the antennas to be tuned to a particular resonance frequency, e.g. to match the resonance frequency of the smartcard antenna or smartphone antenna as discussed above (in order to improve the strength of the inductive coupling).

The oscillating circuits may each comprise only passive electronic components (also referred to as discrete electronic components). These components may include capacitor, resistors, and/or inductors, and the oscillating circuits may comprise no electronic components other than capacitor, resistors and inductors. These components are inexpensive to procure and mount, thus meaning the signal booster is cheap and easy to manufacture.

The assembly may comprise an inductor, wherein the first and second antennas are in electrical communication via the inductor. A wire, or wires, may form the first antenna and second antenna. A wire, or wires, may also form the inductor, and the same wire(s) that form the inductor may form the first antenna and the second antenna. The inductor may therefore electrically connect the first antenna and second antenna, as an alternative to or in addition to the oscillating circuits discussed above.

The assembly may comprise a mechanical structure carrying the signal booster.

The structure may comprise a folded template structure. The folded template structure may be held in the folded position with an adhesive. The adhesive may comprise adhesive dots, such as glue dots. Where the structure comprises a folded structure, the smartcard may be held in place by the folded structure. For example, the structure may be configured such that the smartcard is receivable in a cut-out in the structure prior to the structure being folded, such that when the structure is folded the smartcard is held between two portions of the folded structure.

The structure comprises a cut-out and the cut-out may be configured to hold the smartcard.

The structure may comprise the signal booster in the region of the cut-out. The structure may comprise the signal booster in an area that aligns on top of the smartcard after folding the template structure.

The structure may comprise a guide for aligning the assembly in a predetermined position with respect to the smartphone.

The guide may comprise an edge of the structure and/or one or more alignment marks, wherein the edge of the structure and/or one or more alignment marks are configured for aligning the structure with edge(s) of the smartphone. For example, during enrolment the user may align two adjacent edges of the structure with two edges of the smartphone. Alternatively, or additionally, the user may align alignment marks with a particular edge or edges of the smartphone. Alignment marks may comprise visual indicators such as arrows and/or text, for example instructing a user to align a particular edge of the structure with the smartphone.

The structure may be formed from a paper-based material, such as cardboard, card stock, paperboard, paper, or the like. This makes it cheap to produce and easy to recycle.

The NFC signal booster may be manufactured as a plastic foil with a metal antenna, e.g. PVC with etched aluminium and the structure when be combined with the signal booster may be designed for easy separation of the base material (e.g. cardboard) from the signal booster to simplify recycling.

The structure may be substantially flat. The structure may be less than 5 mm thick. Optionally, the structure may be less than 2 mm thick or less than 1 mm thick. Having a thin structure allows the structure to be easily packaged and sent to a user for enrolment, for example in an envelope sent via a postal service or the like.

The structure may comprise a first guide for (i.e. for use in an enrolment method with) a first smartphone model or family of smartphone models, and a second guide for a second smartphone model or family of smartphone models. In this way a single structure may be suitable for a range of smartphone models. The structure may comprise any number of guides for use with any number of smartphone models.

The structure may be configured to allow a selection of which of the guides is exposed for use by removing part of the structure. For example, the two (or any number of) guides may come as part of a single structure, with one guide on a portion of the structure surrounding another guide. Perforations may be present in the structure for removing the surrounding portion of the structure to expose the inner guide. Alternatively, a single structure may comprise a plurality of guides usable without modification to the structure.

The structure may be in the form of a foil or film. The foil or film may be the same size as the smartcard. The foil or film may comprise an adhesive for attaching the structure to the smartcard, which may be provided on one side of the structure, such that foil or film is a sticker that may be removably attached to the smartcard.

The signal booster and/or structure is may be removably attached to a surface of the smartcard. This attachment may be made using adhesive.

The smartcard may have a size in accordance with an ID-1 card (following ISO/IEC 7810). In particular, the smartcard may have a size of 85.60 mm (+0.12 mm/−0.13 mm) by 53.98 mm (+0.05 mm/−0.06 mm) and rounded corners with a radius of 2.88-3.48 mm, and a thickness of 0.76 (+0.08 mm/−0.08 mm). The smartcard may more generally have a size of approximately 86 by 54 millimetres.

The smartcard may be any one of an access card, a payment card (e.g. one of a credit card, a debit card and a prepaid card), a loyalty card and an identity card.

The smartcard may be configured to communicate via a wireless/contactless communication protocol, such as e.g. ISO/IEC 14443-3. The smartcard may be configured to communicate with the smartphone, for example via such protocol. The smartcard may comprise a smartcard chip.

The biometric capture device may be a fingerprint sensor.

The signal booster and/or the structure may comprise an aperture configured such that, when the antenna of the smartcard is aligned with the first antenna of the signal booster, the fingerprint sensor of the smartcard is accessible through the aperture.

According to a second aspect, the present invention provides a system for biometric enrolment of a biometrically-authorisable smartcard, the system comprising: an assembly according to the first aspect (including any of the optional features described herein), and a smartphone comprising a near field communication antenna.

The second antenna may substantially align with the near field communication antenna of the smartphone. A size and/or a shape and/or resonance frequency of the second antenna may match a size and/or a shape and/or resonance frequency of the near field communication antenna of the smartphone.

A smartphone is a term used to describe a mobile phone that performs many of the functions of a computer, typically having a touchscreen interface, internet access, and an operating system capable of running downloaded applications. The enrolment process may be guided by an application on the smartphone. The enrolment method of the third aspect discussed below may be guided by the application.

The smartphone may be a device owned by or known to the user.

According to a third aspect the present invention provides a method of enrolling a user onto the smartcard in a system according to the second aspect (including any of the optional features described herein), the method comprising: supplying power from the smartphone to the smartcard via the first antenna and the second antenna.

The assembly may be placed in front of or behind the smartphone, e.g. where a display screen of the smartphone is on a front side of the smartphone. The side on which the assembly is to be placed may depend on the location of the NFC antennas of the smartphone. For example, if the NFC antenna of the smartphone is located proximate the rear side of the phone, the assembly may be placed behind the smartphone, in order to be nearer the NFC antenna to improve signal strength. This aids in optimal inductive coupling and the supply of optimal, stable power to the smartcard during enrolment. When discussing the “optimal” inductive coupling, it will be appreciated that this should be interpreted as the optimal within certain constraints of the enrolment method. For example, the position may be limited in that the assembly must be flat against the phone surface for the user to perform the alignment, and/or that the biometric capture device of the smartcard must be accessible and/or that the smartcard may be roughly be aligned with the orientation of the smartphone or an edge of the smartphone.

The method may comprise instructing a user via on-screen instructions on the smartphone how to align the guide of the assembly with respect to the smartphone. The method may comprise instructing a user via on-screen instructions on the smartphone to adjust the alignment of the assembly with respect to the smartphone. This fine-tuning may help to improve the supply of power to the smartcard.

The method may comprise determining a signal strength of near-field communication between the smartphone and the smartcard via the signal booster and instructing the user to adjust the position of the assembly based on the determined signal strength. The signal strength may be determined by measurement from the smartphone. The signal strength may alternatively or additionally be determined by the smartcard and reported back to the smartphone via the local contactless interface. The determining of signal strength and the adjustment may be performed in real-time and/or may be iterative. The user may be instructed via instructions displayed on the screen of the smartphone.

The method may comprise: a user presenting a biometric identifier, such as a fingerprint, to a biometric capture device of the smartcard; capturing biometric probe data using the biometric capture device of the smartcard; generating biometric reference data from the biometric probe data and storing the biometric reference data on the smartcard. The biometric capture device may be a fingerprint sensor, the biometric probe data may be a fingerprint image and the biometric reference data may be fingerprint reference data based on the fingerprint image.

The method may comprise presenting enrolment instructions to the user. Enrolment instructions may be presented on the screen of the smartphone and/or on the assembly itself. For example, the instructions may be printed on a surface of the structure.

The aligning of the assembly with respect to the smartphone may be performed by aligning an edge of the assembly (e.g. an edge of a structure of the assembly, as described above) with respect to an edge of the smartphone.

The method may comprise: aligning the assembly/structure with respect to a smartphone; capturing a first biometric identifier of a user (e.g. their right thumb); changing an orientation of one or more of: the phone, the structure and the smartcard; re-aligning the structure with respect to the smartphone; and capturing a second biometric identifier of the user (e.g. their left thumb). The first and second biometric identifiers may be indicated to the user by the smartphone (e.g. “please place your right thumb onto the sensor of the card”). The re-aligning of the structure with respect to the smartphone may be performed with a second guide of the structure. For example, the re-aligning may be performed by aligning a second, different guide of the structure with the same or a different edge (or edges) of the smartphone. Alternatively, the re-aligning may be performed by aligning the first guide of the structure with a different edge (or edges) of the smartphone. This changing of orientation and re-alignment can make it easier to capture fingerprint images of different fingers (in particular fingers of different hands).

The smartphone may be configured to issue commands to the smartcard for controlling the enrolment process.

The smartphone may provide instructions to the user for relative alignment of smartcard, smartphone, signal booster and/or mechanical structure. The smartphone may also provide instructions for biometric enrolment to the user. Such instructions may be presented e.g. by means of an animated video.

According to a fourth aspect, the present invention provides identifying a smartphone to be used for providing power to a biometrically-authorisable smartcard during enrolment; identifying a configuration of a near field communication antenna of the smartphone and a configuration of an antenna of the smartcard, creating a design of a signal booster having a first antenna configured to inductively couple with the smartcard antenna, and a second antenna configured to inductively couple with the near field communication antenna of the smartphone, wherein the first and second antennas are in electrical communication such that power received from the antenna of the smartphone via the first antenna will be transmitted to the antenna of the smartcard via the second antenna.

The method may be a computer-implemented method, and the step of creating a design may be performed by a computer.

The signal booster may be the signal booster according to the first aspect, including any of the optional features described herein.

Creating the design may comprise identifying a size, and/or a shape and/or a position and/or resonance frequency of the first antenna for substantially optimal inductive coupling between the first antenna and the antenna of the smartcard and/or identifying a size, and/or a shape and/or a position and/or resonance frequency of the second antenna for substantially optimal inductive coupling between the second antenna and the antenna of the smartphone.

The signal booster may include a first oscillating circuit connected to the first antenna and a second oscillating circuit connected to the second antenna, wherein the first and second antennas are in electrical communication via the first and second oscillating circuits. The creating of the design may comprise tuning the first antenna to match a tuning of the antenna of the smartcard and/or tuning the second antenna to match a tuning of the antenna of the smartphone.

The method may comprise identifying a plurality of smartphones, each to be individually used for providing power to a biometrically-authorisable smartcard during enrolment; and identifying a configuration of a near field communication antenna of each of the plurality of smartphones, wherein the creating of the design of the signal booster comprises designing the second antenna to be configured to inductively couple to the near field communication antennas of each of the plurality of smartphones.

In this way a single signal booster may be utilised with a plurality of smartphone models. The creating of the design of the signal booster may comprise averaging of optimal characteristics (e.g. size, resonance frequency, shape) for inductive coupling with each of the models of smartphone.

The method may comprise manufacturing a signal booster according to the design.

According to a fifth aspect, the present invention provides a method comprising:
identifying a model of a smartphone of a user; selecting a signal booster from amongst a plurality of signal boosters, wherein each signal booster comprises a first antenna configured to inductively couple with a smartcard antenna, and a second antenna configured to inductively couple with a near field communication antenna of a smartphone, wherein the first and second antennas are in electrical communication such that power received at the first antenna will be transmitted to the second antenna, and wherein the selected signal booster has a second antenna configured to inductively couple with a near field communication antenna of the identified model of smartphone; and sending the selected signal booster to the user.

The signal booster may be a signal booster including any of the previous optional features described. The signal booster may be carried in a mechanical structure as previously described. The signal booster or mechanical structure carrying the signal booster may be sent to the user via a postal service. Therefore, the signal booster or mechanical structure carrying the signal booster may be configured to be delivered to an end user by a mail delivery service. In particular, the signal booster or mechanical structure carrying the signal booster may fit within the shape and size of a typical letter. For example, the signal booster or mechanical structure carrying the signal booster may have dimensions of less than 24 cm×16 cm×5 mm. The smart card may be pre-mounted with the signal booster or mechanical structure, which then serves as a card carrier when shipping the smartcard to the cardholder.

The method may comprise sending the signal booster or mechanical structure carrying the signal booster to the user along with a biometrically-authorisable smartcard to be enrolled. For example, the signal booster or mechanical structure may be adhesively attached to the smartcard prior to sending the signal booster and smartcard to the user.

The method may comprise receiving a request to send a biometrically-authorisable smartcard to a user, the request comprising an indication of a model of a smartphone in the possession of the user. The request may be sent from a user or from their bank or other card provider.

The method may comprise attaching the signal booster to a smartcard prior to sending the signal booster to the user.

According to a sixth aspect, the present invention provides an assembly comprising: a smartcard comprising an antenna for contactless power harvesting and a biometric capture device, wherein the smartcard is configured to perform biometric enrolment using the biometric capture device and to perform biometric authorisation using the biometric capture device after biometric enrolment has been completed, a smartphone comprising a nearfield communication antenna; and a signal booster comprising a single antenna configured to inductively couple with both the antenna of the smartcard and the near field communication antenna of the smartphone; wherein the single antenna is smaller than the antenna of the smartcard and larger than the near field communication antenna of the smartphone; and wherein the single antenna is configured such that power received from the antenna of the smartphone is transmitted via the single antenna to the antenna of the smartcard.

The antenna of the sixth aspect is smaller than the antenna of the smartcard and larger than the antenna of the smartphone. As such, the booster antenna may couple to each of the smartphone and smartcard antennas more efficiently than the smartphone and smartcard antennas could to one another, enhancing the power transfer between the smartphone and smartcard.

The signal booster of the sixth aspect provides many of the same advantages as described in relation to the first aspect. However, the signal booster of the sixth embodiment may couple with both the smartphone antenna and the smartcard antenna using only a single antenna, which provides a simpler design when compared to the first embodiment. Optionally the coupling factor between the single antenna and both of the smartcard antenna and the nearfield communication antenna of the smartphone is approximately equal.

The assembly of the sixth aspect may incorporate any elements described in respect of the first aspect, except that the signal booster uses a single antenna instead of two antennas.

According to a seventh aspect, the present invention provides a method of enrolling a user onto the smartcard in a system as described above, the method comprising: supplying power from the smartphone to the smartcard via the single antenna.

According to an eighth aspect, the present invention provides a method comprising: identifying a smartphone to be used for providing power to a biometrically-authorisable smartcard during enrolment; identifying a configuration of a near field communication antenna of the smartphone and a configuration of an antenna of the smartcard, creating a design of a signal booster having a single antenna configured to inductively couple with both the smartcard antenna and the near field communication antenna of the smartphone, wherein the antenna is arranged such that power received from the antenna of the smartphone will be transmitted to the antenna of the smartcard via the single antenna.

According to a ninth aspect, the present invention provides a method comprising: identifying a model of a smartphone of a user; selecting a signal booster from amongst a plurality of signal boosters, wherein each signal booster comprises a single antenna configured to inductively couple with both a smartcard antenna and a near field communication antenna of a smartphone, wherein the selected signal booster has a single antenna configured to inductively couple with a near field communication antenna of the identified model of smartphone; and sending the selected signal booster to the user.

Certain preferred embodiments of the invention will now be described by way of example only and with reference to the accompanying drawings, in which:

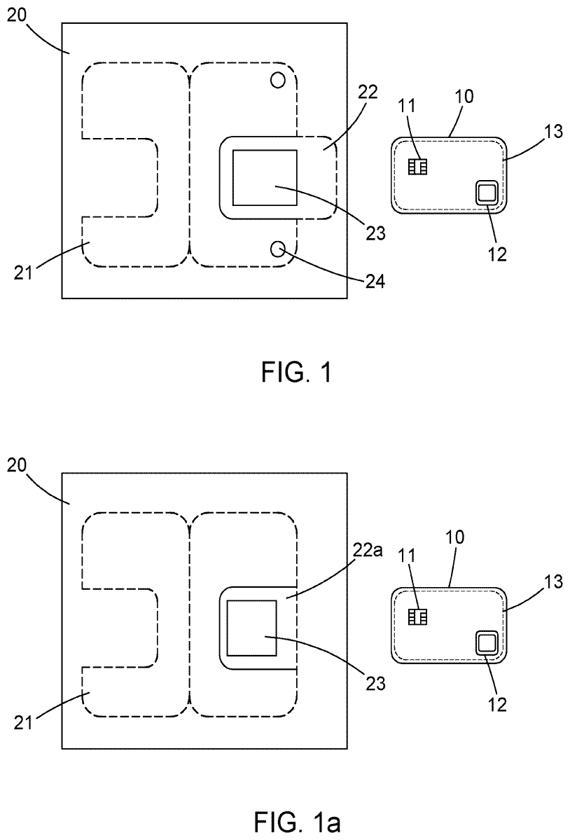

FIG. 1 is a plan view of a structure for aligning a biometrically-authorisable smartcard with respect to a smartphone during biometric enrolment of the smartcard;

FIG. 1a is a plan view of another structure for aligning a biometrically-authorisable smartcard with respect to a smartphone during biometric enrolment of the smartcard;

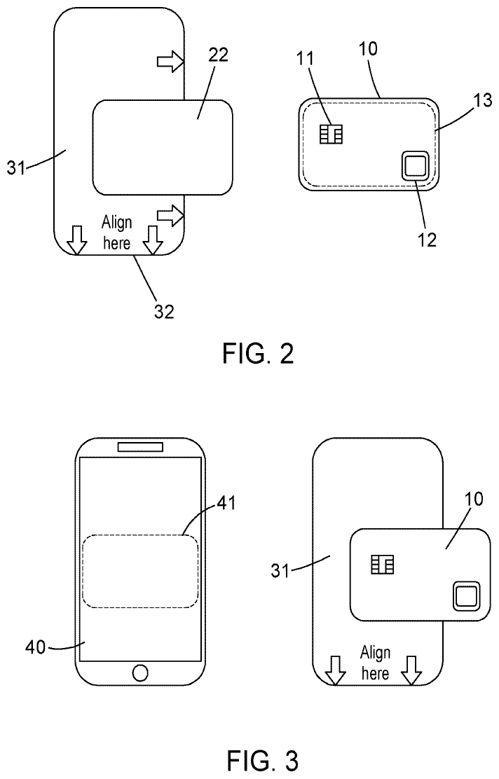

FIG. 2 is a second plan view of the structure shown in FIG. 1, where the structure has been folded;

FIG. 3 is a schematic of a system for biometric enrolment of a biometrically-authorisable smartcard;

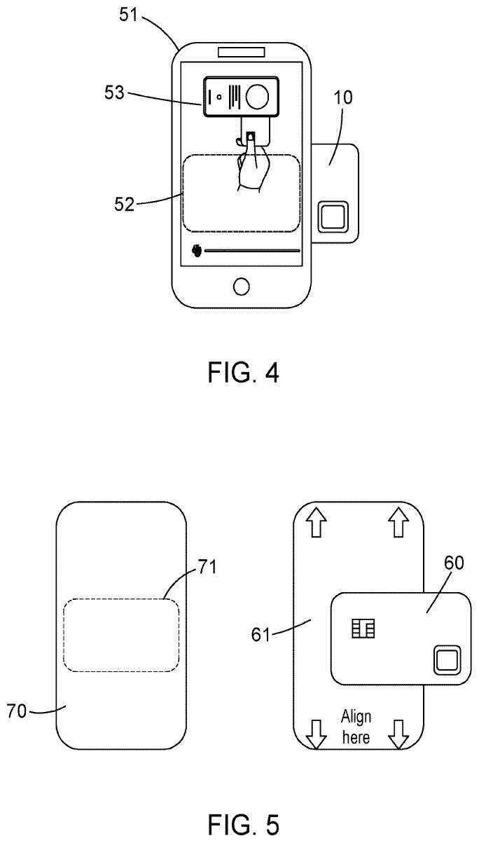

FIG. 4 is a plan view of the system of FIG. 3 during an enrolment process;

FIG. 5 is a schematic of another system for biometric enrolment of a biometrically-authorisable smartcard;

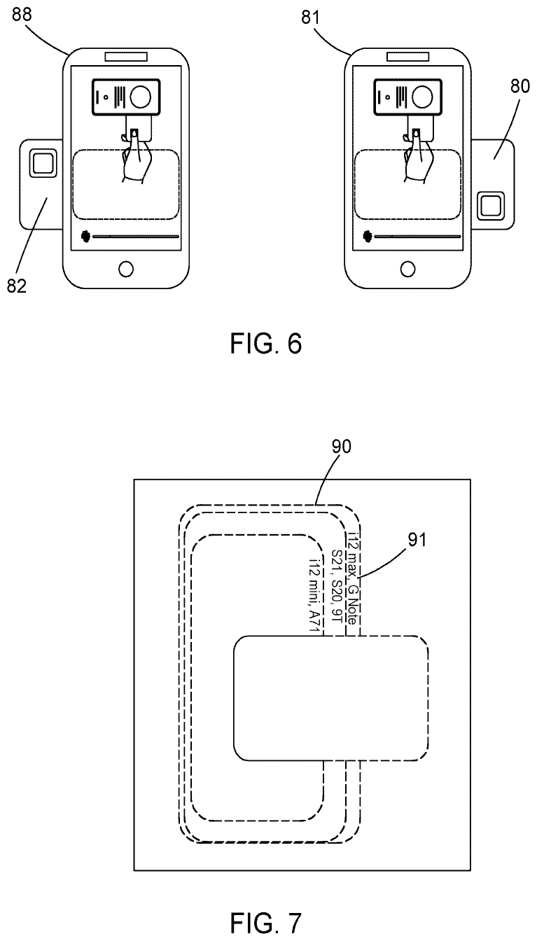

FIG. 6 shows two plan views of the system of FIG. 5 during two different stages of an enrolment process;

FIG. 7 is a plan view of a carrier comprising a plurality of structures for aligning a biometrically-authorisable smartcard with respect to a smartphone during biometric enrolment of the smartcard;

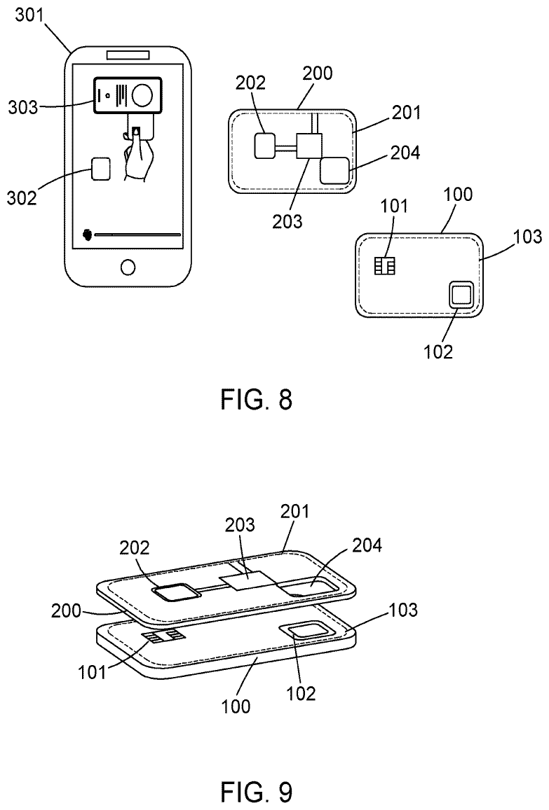

FIG. 8 is a schematic of a system for biometric enrolment of a biometrically-authorisable smartcard;

FIG. 9 is a schematic of an assembly comprising a foil or film carrying a signal booster, and a smartcard;

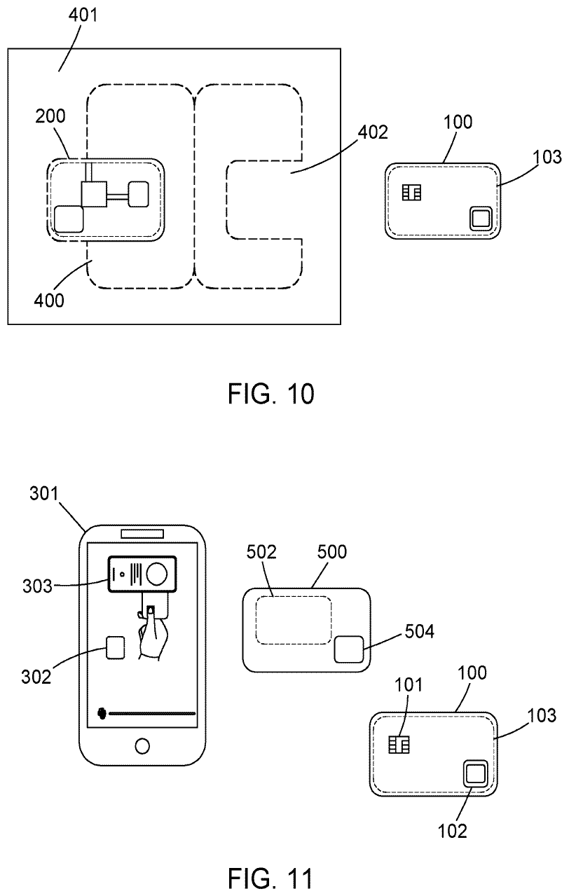

FIG. 10 is a schematic of an assembly comprising a mechanical structure carrying a signal booster, and a smartcard;

FIG. 11 is system for biometric enrolment of a biometrically-authorisable smartcard.

FIG. 1 shows a carrier 20 made from card and comprising a structure 21 for aligning a biometrically-authorisable smartcard 10 with respect to a smartphone during biometric enrolment of the smartcard 10. The structure 21 is separable from the carrier 20 by means of perforations in the card at the edges of the structure 21.

The structure 21 comprises a smartcard area 22 for receiving the smartcard 10 and the smartcard area 22 comprises a foil coating 23. The foil coating 23 implements static friction or adhesion to prevent the card being accidentally removed from the structure 21 during enrolment. In the structure 21 shown in FIG. 1, the smartcard area 22 is large enough to hold the entire smartcard 10, as it extends out to the right of the smartphone (when the structure is aligned therewith).

The structure 21 also comprises glue points 24 for holding the structure 21 in a folded configuration (as described in more detail below, with reference to FIG. 2).

The smartcard 10 has a form factor of an ID-1 card (see ISO/IEC 7810) and therefore has nominal dimensions of 85.60 by 53.98 by 0.76 millimetres (plus or minus allowed tolerances) and rounded corners with a radius of 2.88-3.48 mm.

The smartcard 10 comprises a contact plate 11 (see ISO/IEC 7816-1,-2) and an NFC antenna 13 that is configured to communicate via a contactless protocol, such as ISO/IEC 14443-3.

The smartcard 10 also comprises a biometric capture device in the form of a fingerprint sensor 12 that is configured to be used for capturing of fingerprint data during enrolment of the user onto the smartcard 10 and during subsequent biometric authorisations of the user by the smartcard 10.

In use, the structure 21 is folded along a central dashed line to form a structure as shown in FIG. 2. The cut-out shown on the left hand side of the structure 21 in FIG. 1 results in the forming of a smartcard area 22 being partly surrounded by an edge of card (on three sides) when the structure 21 has been folded. This edge helps to hold the smartcard 10 in place in the smartcard area 22 during the enrolment process.

FIG. 1a shows an alternative card carrier 20 comprising a structure 21 for aligning a biometrically-authorisable smartcard 10 with respect to a smartphone during biometric enrolment of the smartcard 10. This structure 21 is similar to the structure 21 shown in FIG. 1, with the same reference numerals indicating identical features. However, the structure 21 shown in FIG. 2 has a smartcard area 22a that is configured to hold only part of the smartcard 10, as the smartcard area 22a does not extend to the right hand side of the structure 21. It will be appreciated that such an arrangement can still hold the smartcard 10 securely given that it is still surrounded partly on three edges by an edge of the smartcard 10 when the structure 21 is folded.

FIG. 2 shows a structure 31 (identical to that shown in FIG. 1) after it has been folded for use in an enrolment process. Here, it can be seen that the front of the structure comprises a number of guide indications 32 in the form of arrows and text indicating to a user how to align the structure 31 with a smartphone during enrolment. In the arrangement shown, the structure 31 is to be aligned along its bottom and right hand guide edges with the bottom and right hand guide edges of the smartphone, as indicated by the arrows.

The guides of the structure 31 (i.e. guide indications 32 and guide edges) can take other forms, for example the guide indications 32 could be omitted, such that the guides are simply the guide edges of the structure 31. Alternatively, or additionally, one or more guide windows may be formed in the structure 31, and instructions could be given to a user informing them to align the guide edges and/or guide windows of the structure 31 with specific edges or other features of the smartphone.

FIG. 3 shows the structure 31 and smartcard 10 of FIG. 2 as part of a system for biometric enrolment of the smartcard 10. The system comprises a smartphone 40, having a near field communication antenna 41 located towards its rear.

With reference to FIG. 4, in use during the enrolment process, the smartcard 10 is positioned in the smartcard area 22 of the structure 31 as previously described. The structure 31 is then positioned behind the smartphone 51, in contact with its rear surface, and aligned with the bottom and right hand edges of the smartphone 51, in accordance with the guides 32.

The smartphone 51 detects the presence of the smartcard 10, and the enrolment process is guided by an application 53 on the smartphone 51. In this aligned position, the smartphone 51 provides power to the smartcard 10 for enrolment via the NFC antenna 52.

The smartphone 51 is configured to detect if the position of smartcard 10 relative to the NFC antenna 52 is sub-optimal, for example if not enough power is being supplied to the smartcard 10 for enrolment. If this is the case, the app 53 guides the user in adjusting the position of the structure 31 and smartcard 10 accordingly. Such guidance is based on a signal strength measurement of power supplied to the smartcard 10 by the smartphone 51 and is dynamic, in real-time.

Once the smartcard 10 is in a position where sufficient, stable power can be supplied for enrolment, the app 53 guides the user through the enrolment process. The enrolment process comprises: a user presenting a finger to a fingerprint sensor 12 of the smartcard 10; capturing one or more fingerprint images using the fingerprint sensor 12 of the smartcard; generating biometric reference data based on the captured fingerprint images in the sensor, MCU or secure element of the smartcard 10 and storing the biometric reference data on the smartcard 10.

Another system for enrolment is illustrated in FIG. 5. This system comprises a smartcard 60 and smartphone 70 with an NFC antenna 71, which are the same as those of FIGS. 2 to 4, but utilises a different structure 61 for aligning the smartcard 60 with respect to the smartphone 70 during biometric enrolment of the smartcard 60.

In this system, the structure 61 comprises guides at both the top and bottom of the structure 61, each comprising guide indications and guide edges. The guides at the top of the structure 61 are for enrolling fingerprints when the structure 61 is in a first orientation relative to the smartphone 70, and the guides at the bottom of the structure 61 are for aligning the structure 61 with the smartphone 70 when it is in a second orientation.

The guide indications are arrows and texts indicating the edges that are to be aligned with the smartphone 70. The structure is symmetrical in that the guides at the top and bottom edges of the structure are equidistant from the centre of the structure 61 (and the card 60). Due to this symmetry, the structure can align with an edge of the smartphone either along the top or bottom guide edge of the structure 61, depending on the orientation of the structure 61.

This structure 61 can therefore be used in an enrolment process that comprises alignment with an edge of the smartphone 70 before a first sequence of scans for enrolment, the changing of the orientation of the structure 61 (and hence also the smartcard 60) relative to the smartphone 70, and then re-alignment with the same edge of the smartphone before a second sequence of scans for enrolment. This is described in more detail with reference to FIG. 6.

FIG. 6 illustrates (on the left side of the figure) how the smartphone 83 and smartcard 82 are positioned for enrolling a first finger with the smartcard 10 extending to the left of the smartphone e.g. to enrol the left thumb on the left hand side. In this set-up the guides on the bottom of the structure 61 (shown in FIG. 5) are aligned with the bottom edge of the smartphone 83. In this set-up the user may hold the smartphone 83 with the aligned structure 61 and smartcard 82 with the right hand while scanning a finger or thumb of the left hand.

The right side of FIG. 6 shows how the smartphone 83 and smartcard 82 can be re-positioned and re-aligned, with the smartcard 80 then extending to the right of the smartphone 81 for enrolling a second finger e.g. the right thumb. In this set-up, the structure 61 and with it the smartcard 80 has been rotated by 180° about an axis perpendicular to the plane of the structure 61, and the guides at the top of the structure in FIG. 5 are aligned with the bottom of the smartphone 81. In this set-up, the user may hold the smartphone 81 with the re-aligned structure 61 and smartcard 80 with the left hand while scanning a finger or thumb of the right hand.

The structures described herein may be provided in different variants for different mobile phones having different dimensions, antenna locations and optimal positions for the smartcard relative to the smartphone.

In order to accommodate multiple models of mobile phones at once, as illustrated in FIG. 7, a single card structure 90 provides a plurality of pre-cut guides, each guide being for a different model or family of phones, and each being marked with a phone model indicator 91 for a group or family of phones accordingly. The structure 90 is provided with perforations between the various guides (along the dashed lines shown in FIG. 7) in order to allow for a selection of a particular guides that is to be exposed for use. This selection is achieved by tearing along the perforations to remove the part of the structure 90 relating to the surrounding guide, or guides that are not being used.

FIGS. 8 and 9 show a system for biometric enrolment of a biometrically-authorisable smartcard 100. The system comprises the biometrically-authorisable smartcard 100, a signal booster 200 and a smartphone 301. All three components are shown in FIG. 8, whilst FIG. 9 shows the smartcard 100 and signal booster 200 in greater detail.

The smartcard 100 is of the same form previously described, and comprises a fingerprint sensor 102, a secure element 101 and an antenna 103. The smartphone 301 is also of the form previously described, and comprises a near field communication (NFC) antenna 302 and a screen 303.

The signal booster 200 comprises a first antenna 201 configured to inductively couple with the antenna 103 of the smartcard and a second antenna 202 configured to inductively couple with the near field communication antenna 302 of the smartphone.

The first 201 and second 202 antennas are in electrical communication, via a circuit 203 of the signal booster 200 such that, in use, power received via the second antenna 202 from the antenna 302 of the smartphone 301 is transmitted via the first antenna 201 to the antenna 103 of the smartcard 100. Alternatively, the first antenna 201 and second 202 antenna may be in electrical communication through a direct wire connection which may form an inductor.

The second antenna 202 is smaller than the first antenna 201, as the second antenna 202 is designed to be the same shape and size as the antenna 302 of the smartphone 301, whilst the first antenna 201 is designed to be the same size and shape as the antenna 103 of the smartcard 101. Matching the shapes and sizes in this way improves the strength and stability of the respective inductive coupling. The resonance frequency of the second antenna 202 is similar to the antenna 302 of the smartphone 301 and the resonance frequency of the first antenna 201 is similar to that of the antenna 103 of the smartcard 100. Again, this improves the strength and stability of the respective inductive coupling.

For this purpose, the optional circuit 203 comprises a first oscillating circuit connected to the first antenna 201 and which tunes the first antenna 201 to match a tuning of the antenna 103 of the smartcard 100; and a second oscillating circuit connected to the second antenna 202 which tunes the second antenna 202 to match a tuning of the antenna 302 of the smartphone 301.

The circuit 203 (and each of the first and second oscillating circuits) each comprise only passive/discrete electronic components. Passive components are inexpensive to procure and mount, typically small and have no active function; this means the signal booster 200 is cheap and easy to manufacture. Passive components include capacitors, resistors, and inductors. In absence of the circuit 203, an inductor may also be formed by the same wire that forms the first antenna 201, the second antenna 202 and the electrical connection between the two.

FIG. 9 shows an assembly comprising a signal booster 200 and smartcard 100. In this assembly, the signal booster 200 is incorporated into a foil or film that may be adhered to a surface of the smartcard 100. The arrangement shown in FIG. 9 shows the foil or film separate from the smartcard in order to show the alignment of the internal components. There is an adhesive on one side of the signal booster 200 such that the signal booster 200 may be adhered to the surface of the smartcard 100.

In use, the signal booster 200 is removably attached to a surface of the smartcard 100, as shown in FIG. 9, for example via adhesive, before the combined assembly of the signal booster 200 and smartcard 100 is sent to a user for enrolment of the smartcard 100 (using the user's smartphone 100 in a manner as previously described). In one embodiment the signal booster 200 is part of a structure in the form of a foil or film sticker attached to one side of the smartcard 100 that can be removable from the smartcard 100 once enrolment is complete.

The signal booster 200 comprises an aperture 204. When the antenna 103 of the smartcard 100 is aligned with the first antenna 201 of the signal booster 200, the fingerprint sensor 102 of the smartcard 100 is accessible through the aperture 204. The first antenna 201 of the signal booster 200 extends around this aperture 204. This allows for the first antenna 201 to be of a large enough size to match that of the smartcard 100, whilst not obstructing access to the biometric sensor 103 of the smartcard 100 for enrolment.

In use, instructions guiding the user to align the assembly comprising the signal booster 200 and smartcard 100 are provided to the user via the screen 303 of the smartphone 301, in the manner previously described. Once aligned, power form the smartphone antenna 302 is supplied to the smartcard 100 via the signal booster 200 and biometric enrolment can be performed as previously described, using the biometric sensor 102 of the smartcard 100.

FIG. 10 shows another assembly comprising a signal booster 200 and smartcard 100. In this assembly, the signal booster 200 is part of a mechanical structure 400 formed from card that can be removed from a card carrier 401 by tearing perforations in the card. The structure 400 takes a similar folded template form to the guides 21 shown in FIGS. 1, 1a, and 2 and described above, and further includes the signal booster 200. Similar to the structures previously described, the structure 400 also comprises guide indications for aligning it with the smartphone, but these are not shown. The structure 400 also comprises a cut-out 402 for holding the smartcard 100 in the same manner as previously discussed. When the smartcard 100 is held in the cut-out 401, the first antenna 201 of the signal booster 200 is aligned with the antenna 103 of the smartcard 100.

To power the smartcard 100, the assembly of the structure 400 and smartcard 100 is then aligned with a smartphone 301 so that power can be supplied to the smartcard 100 via the signal booster 200 and enrolment can be performed in a manner previously described.

In order to design and manufacture the signal boosters 200 described herein, the following method may be utilised.

First, a signal booster designer will identify a particular model of smartphone 301 that is to be used to provide power to a biometrically-authorisable smartcard 100 during enrolment.

Next, the signal booster designer will identify a configuration of a near field communication antenna 302 of the smartphone 300 and a configuration of an antenna 103 of the smartcard 100. The position may be determined in any suitable manner. In some embodiments, the configurations may be determined analytically, based on knowledge of the smartphone and smartcard. In some embodiments, the location and/or tuning of the antennas 103, 302 may be available from product specifications, or the like.

Based on the configurations of the respective antennas 103, 302, the designer will then create a design of a signal booster 200 having a first antenna 201 configured to inductively couple with the smartcard antenna 103, and a second antenna 202 configured to inductively couple with the near field communication antenna 302 of the smartphone 300.

The size, shape and resonance frequency of the first and second antennas 201, 202 are respectively designed for substantially optimal inductive coupling to the smartcard antenna 103 and smartphone antenna 302. Designing of the resonance frequency of each antenna 201, 202 comprises tuning a first and second oscillating circuit 203 as previously discussed.

The size, shape and resonant frequency for substantially optimal inductive coupling may be determined by experimentation. This experimentation may involve testing different possible configurations to find that which provides sufficient and/or maximum power supply to the smartcard 100.

Once the optimal size, shape and resonant frequency of the first and second antennas have been determined, the designer may then design a structure 400 for carrying the signal booster 200. The signal booster 200 may be incorporated to any of the structures described in relation to FIGS. 1 to 7. For example, the design may be a foil or film as discussed above with reference to FIGS. 8 and 9 or a folded structure as described above in relation to FIG. 10.

The designer may determine suitable first and second antenna 201, 202 configurations for a plurality of different models of smartphones 300. The designer may therefore create a design for a signal booster that comprises a second antenna 202 and/or circuit 203 that is configured to inductively couple with any one antenna 302 of a plurality of smartphones 300. This may be achieved averaging the antenna characteristics of a plurality of models of smartphones 300 such as size, shape and resonance frequency.

Once the design has been completed, one or more signal boosters 200 and/or structures 400 may be manufactured in accordance with the design(s). Any suitable method of manufacture may be used.

A smartcard issuing authority may be provided with a plurality of different signal boosters 200 and/or structures 400, which are suitable for use with a plurality of different models of smartphones 300.

When the smartcard issuing authority receives a request to issue a smartcard to a user, such as from a bank, from the user, or due to an internal workflow, the smartcard issuing authority first identifies a model of a smartphone 300 owned by the user. This may be determined based on the content of the request, may be retrieved from a database, or may be requested either by the user or from the request issuer.

The smartcard issuing authority will then select a suitable signal booster 200 and/or structure 400 corresponding to the identified model of smartphone 300 from amongst the plurality of different signal boosters 200 and/or structures 400. The selected signal booster 200 and/or structure 400 is then sent to the user alongside the smartcard 100, for example by a postal service. This process may also be handled by a dedicated personalization bureau, fulfilment centre or other entity different from the issuing authority.

In some embodiments, such as that of FIGS. 8 and 9, the smartcard 100 and signal booster 200 and/or structure 400 may be removably attached to one another via an adhesive.

In some embodiments, such as that of FIG. 10, the smartcard 100 may be mounted in the structure 400 before sending to the user.

FIG. 11 shows a further system for biometric enrolment of a biometrically-authorisable smartcard 100. The system comprises a biometrically-authorisable smartcard 100, a signal booster 500 and a smartphone 300.

The smartcard 100 is of the same form previously described, and comprises a fingerprint sensor 102, a secure element 101 and an antenna 103. The smartphone 301 is also of the form previously described, and comprises a near field communication (NFC) antenna 302 and a screen 303.

The signal booster 500 in this embodiment comprises a single antenna 502 configured to inductively couple with both the antenna 103 of the smartcard 100 and the near field communication antenna 302 of the smartphone 300.

The antenna 502 is larger than the antenna 302 of the smartphone 301, and smaller than the antenna 103 of the smartcard 100. Sizing the antenna 502 of the signal booster 500 to be between the sizes of the smartcard antenna 103 and the smartphone antenna 502 allows inductive coupling with both the smartphone antenna 302 the smartcard antenna 103. In a preferred implementation, the antenna 502 of the signal booster 500 is sized and tuned so as to achieve approximately equal coupling efficiency with both the antenna 302 of the smartphone 301 and the antenna 103 of the smartcard 100.

The signal booster 500 shown in FIG. 11 may be used in substantially the same manner as the signal booster 200 described above and shown in FIGS. 8 and 9, as shown in FIG. 11. Alternatively, the signal booster 500 may be incorporated in a structure 400 in the same manner as the signal booster 200, shown in FIG. 10

Similarly, the signal booster 500 comprises an aperture 504 which provides the same function as aperture 204 of FIG. 8 along with the same advantages.

1. An assembly comprising a smartcard and a signal booster, wherein the smartcard comprises:
an antenna for contactless power harvesting; and
a biometric capture device,
wherein the smartcard is configured to perform biometric enrolment using the biometric capture device and to perform biometric authorisation using the biometric capture device after biometric enrolment has been completed, and
wherein the signal booster comprises:
a first antenna configured to inductively couple with the smartcard antenna, and
a second antenna configured to inductively couple with a near field communication antenna of a smartphone,
wherein the second antenna is smaller than the first antenna, and
wherein the first and second antennas are in electrical communication such that power received via the second antenna from the antenna of the smartphone is transmitted via the first antenna to the antenna of the smartcard.

2. An assembly according to claim 1, wherein a size and/or a shape and/or resonance frequency of the first antenna matches a size and/or a shape and/or resonance frequency of the smartcard antenna.

3. An assembly according to any preceding claim, comprising either:
a) a first oscillating circuit connected to the first antenna and tuning the first antenna to match a tuning of the antenna of the smartcard; and/or a second oscillating circuit connected to the second antenna, wherein the first and second antennas are in electrical communication via the first and/or second oscillating circuits; or
b) an inductor, wherein the first and second antennas are in electrical communication via the inductor and optionally each of the first and second antennas and the inductor are formed from the same wire.

4. An assembly according to any preceding claim, comprising a mechanical structure carrying the signal booster.

5. An assembly according to claim 4, wherein the structure comprises a guide for aligning the assembly in a predetermined position with respect to the smartphone.

6. An assembly according to claim 5, wherein the guide comprises an edge of the structure, an edge of the signal booster, and/or one or more alignment marks, wherein the guide is configured for aligning the assembly with edge(s) of the smartphone.

7. An assembly according to any of claims 4 to 6, wherein the structure comprises a folded template structure.

8. An assembly according to any of claims 4 to 7, wherein the structure comprises a cut-out and the cut-out is configured to hold the smartcard.

9. An assembly according to any of claims 4 to 8, wherein the structure is formed from a paper-based material, and optionally wherein the structure is less than 2 mm thick.

10. An assembly according to claim 4, wherein the structure is in the form of a foil or film.

11. An assembly according to any preceding claim, wherein the signal booster and/or structure is removably attached to a surface of the smartcard.

12. An assembly according to any preceding claim, wherein the biometric capture device is a fingerprint sensor.

13. An assembly according to claim 12, wherein the signal booster comprises an aperture configured such that, when the antenna of the smartcard is aligned with the first antenna of the signal booster, the fingerprint sensor of the smartcard is accessible through the aperture.

14. A system for biometric enrolment of a biometrically-authorisable smartcard, the system comprising:
an assembly according to any one of claims 1 to 13, and
a smartphone comprising a near field communication antenna.

15. A system according to claim 14, wherein the second antenna substantially aligns with the near field communication antenna of the smartphone, and/or wherein a size and/or a shape and/or resonance frequency of the second antenna matches a size and/or a shape and/or resonance frequency of the near field communication antenna of the smartphone.

16. A method of enrolling a user onto the smartcard in a system according to claim 14 or 15, the method comprising:
supplying power from the smartphone to the smartcard via the first antenna and the second antenna.

17. A method according to claim 16, wherein the smartphone is configured to issue commands to the smartcard for controlling the enrolment process.

18. A method as claimed in claim 16 or 17, comprising:
a user presenting a finger to the fingerprint sensor of the smartcard;
capturing a fingerprint image corresponding to the presented finger using the fingerprint sensor of the smartcard;
generating biometric reference data from the captured fingerprint image; and
storing the biometric reference data on the smartcard.

19. A method comprising:
identifying a smartphone to be used for providing power to a biometrically-authorisable smartcard during enrolment;
identifying a configuration of a near field communication antenna of the smartphone and a configuration of an antenna of the smartcard,
creating a design of a signal booster having a first antenna configured to inductively couple with the smartcard antenna, and a second antenna configured to inductively couple with the near field communication antenna of the smartphone, wherein the first and second antennas are in electrical communication such that power received from the antenna of the smartphone via the first antenna will be transmitted to the antenna of the smartcard via the second antenna.

20. A method as claimed in claim 19, wherein creating the design comprises identifying a size, and/or a shape and/or a position and/or resonant frequency of the first antenna for substantially optimal inductive coupling between the first antenna and the antenna of the smartcard and/or identifying a size, and/or a shape and/or a position and/or resonant frequency of the second antenna for substantially optimal inductive coupling between the second antenna and the antenna of the smartphone.

21. A method as claimed in claim 19 or 20, wherein the signal booster includes a first oscillating circuit connected to the first antenna and a second oscillating circuit connected to the second antenna, wherein the first and second antennas are in electrical communication via the first and second oscillating circuits, and wherein the creating of the design comprises tuning the first antenna to match a tuning of the antenna of the smartcard and/or tuning the second antenna to match a tuning of the antenna of the smartphone.

22. A method as claimed in any of claim 19, 20 or 21, comprising:
identifying a plurality of smartphones, each to be individually used for providing power to a biometrically-authorisable smartcard during enrolment; and
identifying a configuration of a near field communication antenna of each of the plurality of smartphones,
wherein the creating of the design of the signal booster comprises designing the second antenna to inductively couple to the near field communication antennas of each of the plurality of smartphones.

23. A method according to any of claims 19 to 22, the method comprising:
manufacturing a signal booster according to the design.

24. A method comprising:
identifying a model of a smartphone of a user;
selecting a signal booster from amongst a plurality of signal boosters, wherein each signal booster comprises a first antenna configured to inductively couple with a smartcard antenna, and a second antenna configured to inductively couple with a near field communication antenna of a smartphone, wherein the first and second antennas are in electrical communication such that power received at the first antenna will be transmitted to the second antenna, and wherein the selected signal booster has a second antenna configured to inductively couple with a near field communication antenna of the identified model of smartphone; and
sending the selected signal booster to the user.

25. A method according to claim 24, comprising:
receiving a request to send a smartcard to a user, the request comprising an indication of the model of a smartphone in the possession of the user.

26. A method according to claim 24 or 25, comprising:
attaching the signal booster to a smartcard prior to sending the signal booster to the user, wherein the signal booster and the smartcard are sent together to the user.

27. An assembly comprising:
a smartcard comprising an antenna for contactless power harvesting and a biometric capture device, wherein the smartcard is configured to perform biometric enrolment using the biometric capture device and to perform biometric authorisation using the biometric capture device after biometric enrolment has been completed,
a smartphone comprising a nearfield communication antenna; and
a signal booster comprising a single antenna configured to inductively couple with both the antenna of the smartcard and the near field communication antenna of the smartphone;
wherein the single antenna is smaller than the antenna of the smartcard and larger than the near field communication antenna of the smartphone; and
wherein the single antenna is configured such that power received from the antenna of the smartphone is transmitted via the single antenna to the antenna of the smartcard.

28. An assembly according to claim 27, wherein a size and/or resonance frequency of the single antenna is between a size and/or resonance frequency of the smartcard antenna and the near field communication antenna of the smartphone, and optionally wherein a coupling efficiency between the single antenna and both of the smartcard antenna and the nearfield communication antenna of the smartphone is approximately equal.

29. An assembly according to claim 27 or 28, comprising an oscillating circuit connected to the single antenna and tuning the single antenna to be between a tuning of the antenna of the smartcard and a tuning of the near field communication antenna of the smartphone.

30. An assembly according to claim 27, 28 or 29, comprising a mechanical structure carrying the signal booster.

31. An assembly according to claim 30, wherein the structure comprises a guide for aligning the assembly in a predetermined position with respect to the smartphone.

32. An assembly according to claim 31, wherein the guide comprises an edge of the structure, an edge of the signal booster, and/or one or more alignment marks, wherein the guide is configured for aligning the assembly with edge(s) of the smartphone.

33. An assembly according to any of claims 30 to 32, wherein the structure comprises a folded template structure.

34. An assembly according to any of claims 30 to 33, wherein the structure comprises a cut-out and the cut-out is configured to hold the smartcard.

35. An assembly according to any of claims 30 to 34, wherein the structure is formed from a paper-based material, and optionally wherein the structure is less than 2 mm thick.

36. An assembly according to claim 30, wherein the structure is in the form of a foil or film.

37. An assembly according to any of claims 27 to 36, wherein the signal booster and/or structure is removably attached to a surface of the smartcard.

38. An assembly according to any of claims 27 to 37, wherein the biometric capture device is a fingerprint sensor.

39. An assembly according to claim 38, wherein the signal booster comprises an aperture configured such that, when the antenna of the smartcard is aligned with the single antenna of the signal booster, the fingerprint sensor of the smartcard is accessible through the aperture.

40. An assembly according to any of claims 27 to 39, wherein the single antenna substantially surrounds the near field communication antenna of the smartphone, and/or wherein a resonance frequency of the single antenna is smaller than a resonance frequency of the near field communication antenna of the smartphone.

41. A method of enrolling a user onto the smartcard in a system according to claim 27 or 40, the method comprising:
supplying power from the smartphone to the smartcard via the single antenna.

42. A method according to claim 41, wherein the smartphone is configured to issue commands to the smartcard for controlling the enrolment process.

43. A method as claimed in claim 41 or 42, comprising:
a user presenting a finger to the fingerprint sensor of the smartcard;
capturing a fingerprint image corresponding to the presented finger using the fingerprint sensor of the smartcard;
generating biometric reference data from the captured fingerprint image; and
storing the biometric reference data on the smartcard.

44. A method comprising:
identifying a smartphone to be used for providing power to a biometrically-authorisable smartcard during enrolment;
identifying a configuration of a near field communication antenna of the smartphone and a configuration of an antenna of the smartcard,
creating a design of a signal booster having a single antenna configured to inductively couple with both the smartcard antenna and the near field communication antenna of the smartphone, wherein the antenna is arranged such that power received from the antenna of the smartphone will be transmitted to the antenna of the smartcard via the single antenna.

45. A method as claimed in claim 44, wherein creating the design comprises identifying a size, and/or a shape and/or a position and/or resonant frequency of the antenna for substantially optimal inductive coupling between the single antenna and both the antenna of the smartcard and the near field communication antenna of the smartphone; and optionally wherein the substantially optimal coupling is an approximately equal coupling between the single antenna and both of the smartcard antenna and the nearfield communication antenna of the smartphone.

46. A method as claimed in claim 44 or 45, wherein the signal booster includes an oscillating circuit connected to the single antenna, wherein the creating of the design comprises tuning the single antenna to be between a tuning of the antenna of the smartcard and a tuning of the near field communication antenna of the smartphone.

47. A method as claimed in any of claim 44, 45 or 46, comprising:
identifying a plurality of smartphones, each to be individually used for providing power to a biometrically-authorisable smartcard during enrolment; and
identifying a configuration of a near field communication antenna of each of the plurality of smartphones,
wherein the creating of the design of the signal booster comprises designing the single antenna to inductively couple to the near field communication antenna of each of the plurality of smartphones.

48. A method according to any of claims 44 to 47, the method comprising:
manufacturing a signal booster according to the design.

49. A method comprising:
identifying a model of a smartphone of a user;
selecting a signal booster from amongst a plurality of signal boosters, wherein each signal booster comprises a single antenna configured to inductively couple with both a smartcard antenna and a near field communication antenna of a smartphone, wherein the selected signal booster has a single antenna configured to inductively couple with a near field communication antenna of the identified model of smartphone; and
sending the selected signal booster to the user.

50. A method according to claim 49, comprising:
receiving a request to send a smartcard to a user, the request comprising an indication of the model of a smartphone in the possession of the user.

51. A method according to claim 49 or 50, comprising:
attaching the signal booster to a smartcard prior to sending the signal booster to the user.
